(19) United States
(12) Patent Application Publication
(10) Pub. No.: US 2024/0065233 A1
(43) Pub. Date: Feb. 29, 2024

(54) METHOD AND SYSTEM FOR ESTRUS DETECTION OF A MAMMAL

(71) Applicant: Nedap N.V., Groenlo (NL)

(72) Inventors: Jeroen WATERINK, Doetinchem (NL); Robin Benjamin Niko ALY, Enschede (NL); Arnoldus Gerardus Franciscus HARBERS, Groenlo (NL)

(21) Appl. No.: 18/271,979

(22) PCT Filed: Jan. 17, 2022
(86) PCT No.: PCT/NL2022/050012

§ 371 Date: Jul. 12, 2023

(30) Foreign Application Priority Data
Jan. 18, 2021 (NL) 2027332

(51) Int. Cl. A01K 29/00

(52) U.S. Cl. CPC A01K 29/005

(57) ABSTRACT

A method for estrus detection of a mammal is provided. Activity data is obtained that is indicative of a degree and/or type of activity as a function of time for an activity of the mammal, wherein an indicated degree and/or type of activity is selected from at least two potential indications for a degree and/or type of activity. Based on the activity data, one or more activity switch counts are determined. The activity switch counts are indicative of a number of switches in indicated type and/or degree of activity during an evaluation time interval of a predetermined duration. Respective relative activity switch scores are computed for the activity switch counts. On the basis of the respective relative activity switch scores it is determined whether the mammal is in estrus.

### BACKGROUND

Reproduction is a key factor for farm performance, since milk or beef production of a mammal, in particular cattle, such as a cow begins with the birth of a calf. Therefore, detecting estrus, the only period when the cow is susceptible to pregnancy, is crucial for farm efficiency. FIG. 1 shows a typical estrus timeline for a cow. During its estrus cycle of approximately 21 days the cow has a period of about 24 to 30 hours wherein it is estrus. It is known that insemination should preferably take place within 5-17 hours from the onset of estrus to optimize the chance of a success.

Usually, the estrus state is of the type “behavioral estrus” which can be relatively easy recognized by the farmer. However, approximately 20% of the times the estrus state is of the type “silent estrus” in which case the mammal does not clearly show behavioral changes. Whether an estrus state is silent or not may be different for mutually different mammals. Furthermore, it may be the case that one and the same mammal sometimes has a silent estrus and sometimes has a behavioral estrus.

Also, the estrus cycle may deviate from the typical 21 day cycle. It is therefore often difficult to determine the optimal point in time for insemination. One indication of a mammal being in estrus is the progesterone level in the milk. Also, it is possible to recognize that a mammal is in estrus by ultrasound technology. However, these approaches do either not give a very precise indication or involve high costs prohibiting an extensive implementation. Accordingly, a need exists for a reliable low cost approach for both behavioral and silent estrus detection.

### SUMMARY

According to a first aspect of the present disclosure, a method for estrus detection of a mammal is provided. The mammal is for example a cow. In summary the method comprises obtaining activity data, determining activity switch counts, computing relative activity switch scores and determining whether or not the mammal is in estrus on the basis of the relative activity switch scores.

The obtained activity data is indicative for a degree and/or type of activity as a function of time for an activity of the mammal. The indicated degree and/or type of activity is selected from at least two potential indications for a degree and/or type of activity. The at least two potential indications are for example an indication of the presence of an activity (regardless the type of activity) and an indication of the absence of an activity. Typically the indication is selected from a larger number of potential indications, for example an indication of eating, drinking, grooming, panting, perching, licking, grazing, sleeping, resting, ruminating, inactive, lying on its left side, lying on its right side, standing, walking, standing up, lying down, changing lying position from left to right or vice versa. Off the shelve products are available with which activity data can be obtained.

In embodiments of the method activity data is obtained using one or more motion detectors and/or acceleration detectors carried by the mammal. By way of example, the one or more motion detectors and/or acceleration detectors are incorporated in a neck tag, leg tag, ear tag, rumen bolus carried by the mammal. In other embodiments, activity data is obtained by a visual monitoring system that recognizes individual animals and analyzes their activity. In still further embodiments the method employs both motion detectors and/or acceleration detectors and a visual monitoring system.

The obtained activity data is used to determine one or more activity switch counts indicative for a number of switches in indicated type and/or degree of activity during an evaluation time interval of a predetermined duration. By way of explanatory example, it may be determined how frequent the indicated degree of activity of the mammal switches from active to not-active in the evaluation time interval. In this explanatory example the frequency of switches from not-active to active will differ at most 1 from the frequency of switches from active to not-active. As noted above, in practice the indication is selected from a larger number of potential indications. Therewith, the number of activity switch counts that can be determined is equal to N(N−1), where N is the number of potential indications. Generally the frequency of switches from a first activity to a second activity may differ substantially from the frequency of switches from the second activity to the first activity. It can for example be the case that the mammal frequently switches from the activity eating to the activity ruminating, frequently switches from the activity ruminating to the activity drinking and frequently switches from the activity drinking to the activity eating, but that switches from the activity ruminating to the activity eating are not frequent.

The predetermined duration of the evaluation time interval is typically in a range between 1 and 48 hours. If the predetermined duration is substantially shorter than 1 hour, then the activity switch count will be rendered unreliable by quantization noise. If the predetermined duration is substantially longer than 48 hours, it becomes more likely that the evaluation time interval partly extends during a time period wherein the mammal is in estrus and partly extends during a time-period wherein the mammal is not in estrus, so that the activity switch count obtained is less relevant to either of the estrus state and the anestrus state.

Respective relative activity switch scores are then computed from the activity switch counts. In an embodiment, a respective relative activity switch score of an activity switch count is a percentage of said active switch count relative to a total count of switches. Alternatively or additionally, a respective relative activity switch score (ZLij, ZSij) of an activity switch count indicates how said activity switch count relates to at least one estimated overall distribution (ASLij, ASSij) of said activity switch counts, or indicates how the percentage of said active switch count relative to a total count of switches relates to at least one estimated overall distribution (ASLij, ASSij) of said percentage.

A higher magnitude of a relative activity switch score in relation to an estimated overall distribution indicates that the value of the associated activity switch count or the percentage of that activity switch count has a relatively large deviation from the mean value of the distribution relative to the standard deviation of the distribution. In one example, the relative activity switch score is a ratio of which the numerator is the difference of the value determined for the activity switch indicator and the mean value of said indicator in the overall activity switch score distribution and of which the denominator is the standard deviation of the overall activity switch score distribution. As another example, the relative activity switch score indicates a percentile associated with the activity switch count or associated with the percentage thereof in the estimated overall distribution.

In a first embodiment the estimated overall distribution of an activity switch count is a distribution of activity switch scores obtained for respective mutually non-overlapping time intervals of the predetermined duration in a first relatively long period of time. This first period of time may for example start around the first day of lactation, e.g. at one month or a few months or a year after said first day of lactation.

In a second embodiment the distribution of activity switch scores is obtained for respective mutually non-overlapping time intervals of said predetermined duration in a second period of time which is shorter, e.g. at least five times shorter than said first period of time, e.g. starting at the earliest 30 days before the predetermined time interval. The first period of time and/or the second period of time may in principle extend until the start of the evaluation time interval. However, in practice it may be the case that no data was available short before the start of the evaluation time interval, so that the first period of time and/or the second period of time end at a day preceding the start of the evaluation time interval.

It is an advantage of the first embodiment that the distribution can be estimated with high accuracy provided that no systematic changes in the animals behavior occur other than during its estrus cycle. It is an advantage of the second embodiment that the second distribution is particularly relevant for the actual condition of the animal.

In a third embodiment a first and a second relative activity switch score can be computed for an activity switch count or for a percentage of an activity switch count based on the estimated overall distributions obtained according to the first embodiment and the second embodiment respectively.

Having computed relative activity switch scores for the evaluation time interval, it is determined whether or not the mammal is in estrus on the basis of said relative activity switch scores so obtained.

In a first exemplary embodiment the determination is made by a comparison of one or more relative activity switch scores with a respective lower threshold value and/or a respective higher threshold value. Each comparison of a relative activity switch score with its respective lower threshold value and/or with its respective higher threshold value results in a respective estrus indication signal. In case a plurality of estrus indication signals is computed, a determination whether or not the mammal is in estrus can then be made by combining the estrus indication signals, for example by counting the number of estrus indication signals that indicated that the mammal is in estrus. A higher count is indicative for a higher likelihood that the mammal is in estrus. Combining may also be performed as a Boolean operation, e.g. using an AND gate that determines that the mammal is in estrus if and only if all the estrus indication signals indicate that the mammal is in estrus.

In an embodiment a trained machine learning model is used to determine whether or not the mammal is in estrus on the basis of the activity switch scores.

In a preceding step the machine learning model is trained with a plurality of sample data pairs obtained for mutually different sample time intervals, each sample data pair for a sample time interval including a respective set of activity switch scores obtained for that sample time interval and an indication of the Ground Truth (GT-indication) for that sample time interval. The GT-indication is for example provided by a hormone concentration value obtained by measurement of a concentration of a hormone, e.g. progesterone, associated with an estrus state of the mammal in milk or blood delivered by the mammal during that sample time interval.

In an alternative embodiment the Ground Truth is indicated by whether or not an insemination was successful. Also fine grained ground truth labels can be obtained with ultrasound measurements. In an embodiment, the machine learning model is an XGBoost classifier. This embodiment is particular advantageous if only a small dataset for training is available. Also other classifiers, such as a Gradient boost classifier, a naive Bayes classifier, a support vector machine or a decision tree classifier are suitable. Once the machine learning model is trained, it may be used for performing the determining step.

It is noted that the extent to which a relative activity switch score is indicative for the occurrence of a silent estrus may be different for mutually different mammals of a same kind, e.g. mutually different cows. E.g. for some cows a first relative activity switch score may be a strong indication for the occurrence of a silent estrus and for other cows it may be a second relative activity switch score instead. Specific examples are increased switch scores from switching between eating and ruminating, and switching from inactive to eating. Accordingly, a classifier trained or configured for a particular mammal of specific kind, e.g. of the kind cow, will generally predict a silent estrus of another cow with less accuracy than for the cow for which it was trained or configured. In an embodiment a more generally applicable classifier is obtained by training a machine learning model on the basis of training data comprising relative activity switch scores and the associated ground truth for a plurality of mammals of the same kind.

It was recognized by the inventors that even though the indicative value of relative activity switch scores differ for mutually different mammals of the same kind their indicative value for the occurrence of a silent estrus is still substantially stronger than that provided by the “raw” activity data. Therefore a classifier trained or configured to detect a silent estrus for a particular mammal on the basis of relative activity switch scores will in general also perform better for another species of the same type of mammal than if that classifier were trained or configured to detect a silent estrus for a particular mammal on the basis of raw activity data.

According to a second aspect, a system for estrus detection of a mammal is provided.

According to a third aspect a record-carrier comprising a computer program with instructions that cause a general purpose computer to perform one or more steps of the method according to the first aspect.

### BRIEF DESCRIPTION OF THE DRAWINGS

These and other aspects of the invention are described with reference to the drawings. Therein:

FIG. 1 shows a typical estrus timeline for a cow;

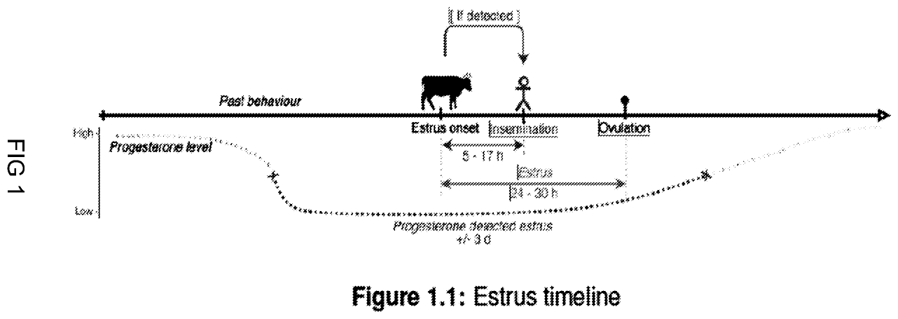

FIG. 2 schematically shows a first embodiment of a method according to the first aspect;

FIG. 3 schematically shows a second embodiment of a method according to the first aspect;

FIG. 4 schematically shows a third embodiment of a method according to the first aspect;

FIG. 5A schematically shows exemplary timeline data in a data format used herewith; FIG. 5B shows switch related data derived therefrom;

FIG. 6 shows exemplary activity data of a cow;

FIG. 7 shows other exemplary activity data of a cow;

FIG. 8 shows activity switch related data for the same cow over the same period of time;

FIG. 9 schematically shows a system for estrus detection of a mammal according to the second aspect.

### DETAILED DESCRIPTION OF EMBODIMENTS

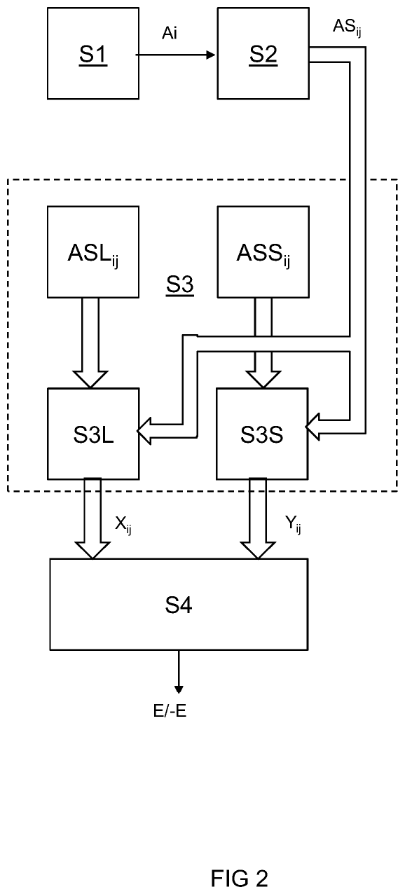

FIG. 2 schematically shows a method for estrus detection of a mammal.

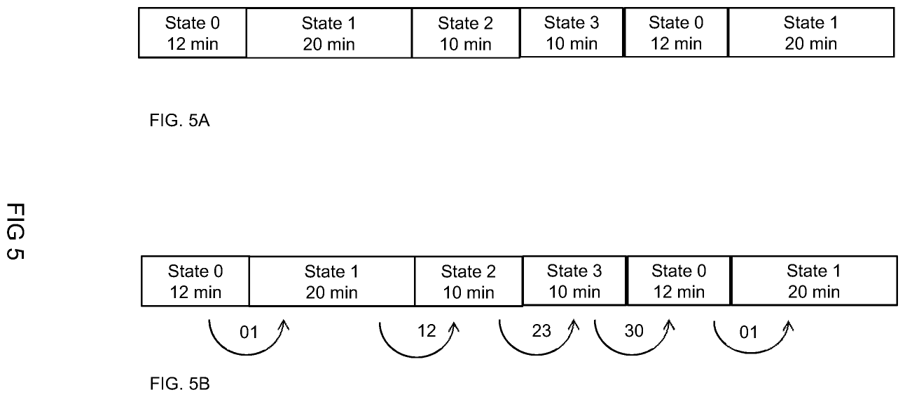

In step S1 activity data Ai is obtained that is indicative for a degree and/or type of activity as a function of time for an activity of the mammal. An indication of a degree of activity specifies an extent to which an activity occurs. In one embodiment this indication does not relate to a particular activity, but merely indicates to which extent the animal is active. This can be a binary indicator, i.e. indicated whether or not the mammal is active, or may be a more fine grained indicator, e.g. specifying a degree of activity in 16 levels. In the present embodiment the activity data specifically indicates a type of activity. The type of activity is selected from a plurality of potential indications like an indication of eating, ruminating, sleeping, walking. Off the shelve products are available with which activity data can be obtained, such as the Nedap Smarttag, the Heattime HR-LD, Pro+, both from SCR, the Smartbow sensor and Sensoor available from CowManager. Activity data Ai may be provided in the format shown in FIG. 5A.

In step S2 activity switch counts ASij are computed, which are indicative for a number of switches in indicated type and/or degree of activity during an evaluation time interval of a predetermined duration as shown in FIG. 5B. In one embodiment, the evaluation time intervals are mutually distinct. In another embodiment the evaluation time intervals are mutually overlapping. For example, the evaluation time intervals may have a predetermined duration of e.g. 3 or 5 days and each next evaluation time interval is shifted in time by a fraction of the length of the predetermined e.g. with a number of hours, e.g. in the range of 1-24 hours. Exemplary activity switch counts to be computed are a number of times the mammal switches from the activity “drinking” to the activity “eating” during an evaluation time interval, or a number of times the mammal switches from the activity “walking” to the activity “lying”. Starting from a number of N potential activity indicators Ai, i=1, . . . , N, a number of N(N−1) activity switch counts ASij may be determined for a switch from one activity i to another activity j. Alternatively a smaller number of activity switch counts may be selected.

In step S3 respective relative activity switch scores are computed that indicate how the activity switch counts relate to at least one estimated overall distribution of said activity switch counts ASIᵢⱼ. In the example shown, step S3 comprises a sub-step S3L, wherein the activity switch counts AS are compared with a long term distribution ASIᵢⱼ. In a sub-step S3S, the activity switch counts ASᵢⱼ are compared with a short term distribution ASSᵢⱼ. Therewith first relative activity switch scores, also denoted as “X-factors” are computed as:

$${X}_{i j} = \frac{A {S}_{ij} - [ A S {S}_{ij} ]}{σ 〈 A S {S}_{ij} 〉}$$

Second relative activity switch scores, also denoted as “Y-factors” are computed as:

$${Y}_{ij} = \frac{A {S}_{ij} - [ A S {L}_{ij} ]}{σ 〈 A S {L}_{ij} 〉}$$

Therein the short term distribution ASSᵢⱼ for a switch ij is the distribution of activity switch counts obtained in a recent period preceding the evaluation time interval, for example obtained in the recent past, e.g. during a period of 10 days directly preceding the evaluation time interval. Furthermore the activity switch counts are obtained in time intervals for the same timeslot as that of the evaluation time interval. For example, if the evaluation time interval extends in the timeslot between 14.00 h and 16.00 h, then the short term distribution ASSij is the distribution of the switch counts ASij determined for that time slot in the recent past. If the evaluation time interval extends in a 24 hour timeslot, then the short term distribution ASSij is the distribution of the switch counts ASij determined for each period of 24 hours in the recent past.

The long term distribution ASLᵢⱼ for a switch ij is the distribution of activity switch counts obtained in a period starting from the first day of lactation until the evaluation time interval. Also the long term distribution pertains to the activity switch counts that are obtained in time intervals starting for the same timeslot as that of the evaluation time interval.

Third relative activity switch scores, denoted as Z-factors are determined similarly as the second relative activity switch scores, but using an alternative long term distribution. This is the distribution of all activity switch counts obtained in a period starting from the first day of lactation until the evaluation time interval, not restricted to reference time intervals starting within a particular timeslot.

In a step S4 it is determined whether or not (E/−E) the mammal is in estrus on the basis of the various relative activity switch scores. Various options are possible. For example in step S4 a lookup table may be used which indicates for respective combinations of switch scores a respective indication E/−E to indicate whether or not the mammal is likely to be in estrus or not.

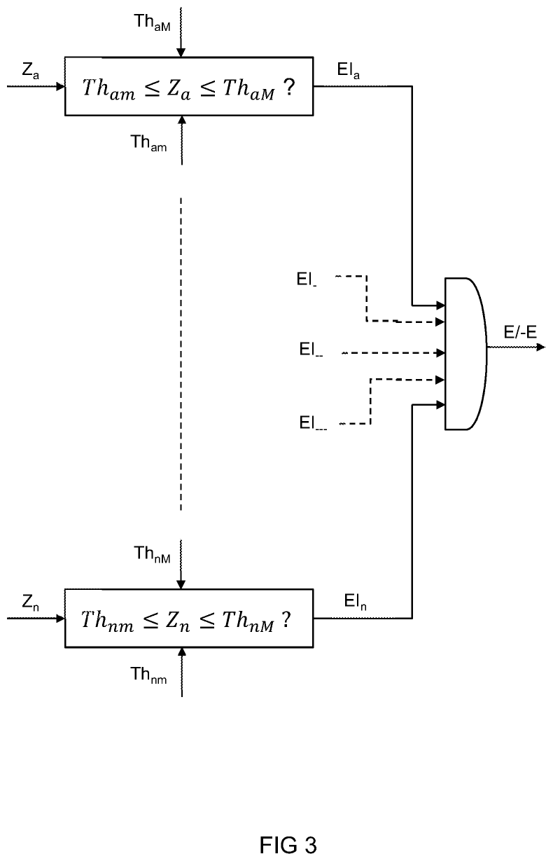

In another example, illustrated in FIG. 3, the determination is made by a comparison of one or more relative activity switch scores, denoted herein as Za, . . . , Zn with a respective lower threshold value Thₐₘ and/or a respective higher threshold value Th_{aM}. Each comparison of a relative activity switch score with its respective lower threshold value and/or with its respective higher threshold value results in a respective estrus indication signal EIₐ, . . . , EIₙ. In case a plurality of estrus indication signals is computed, a determination whether or not the mammal is in estrus can then be made by combining the estrus indication signals, for example by counting the number of estrus indication signals that indicated that the mammal is in estrus. A higher count is indicative for a higher likelihood that the mammal is in estrus. In the example shown in FIG. 3, combining is performed as a Boolean operation, e.g. using an AND gate that determines that the mammal is in estrus E if and only if all the estrus indication signals EIₐ, . . . , EIₙ. indicate that the mammal is in estrus.

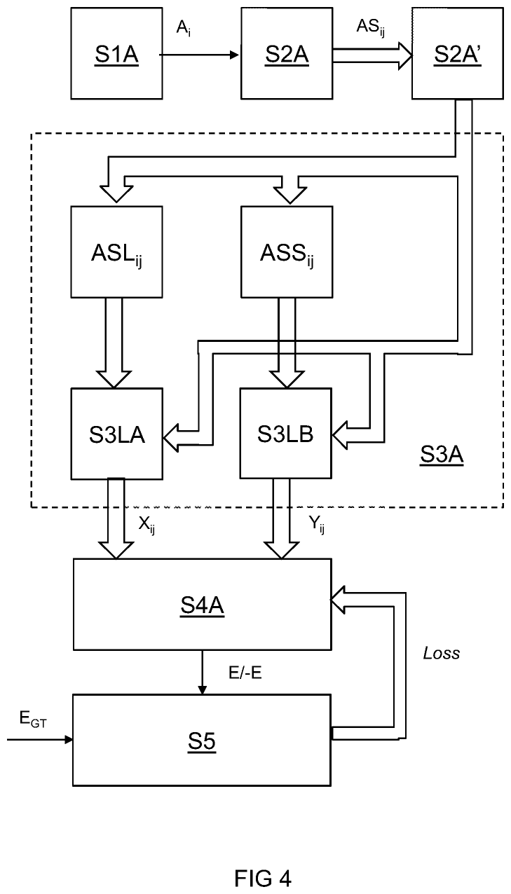

In some embodiments step S4 uses a trained neural network. FIG. 4 shows an exemplary method of training a neural network, e.g. a multilayer perceptron, which after being trained can subsequently be used in the method described with reference to FIG. 2. The training involves a step S1A. As in step S1 of FIG. 2, activity data Aᵢ is obtained therewith that is indicative for a degree and/or type of activity as a function of time for an activity of the mammal. Similar as in step S2 of FIG. 2, in step S2A of FIG. 4, activity switch counts ASᵢⱼ are computed, which are indicative for a number of switches in indicated type and/or degree of activity during an evaluation time interval of a predetermined duration. In step S2A′ the switch counts ASᵢⱼ are used to facilitate generation of distribution information for each type of activity switch ij. In one embodiment all collected counts for a type of switch are stored and at a later point in time for example during execution of the method of FIG. 4, a selection of the stored data is made to determine properties of the distribution to be used for computing the X-factor, Y-factor and Z-factor. Alternatively, the collected switch count data may be directly processed to update distribution parameters. Steps S1A, S2A and S2A′ typically are repeated a plurality of times for respective mutually different, but possibly overlapping, time windows.

The neural network can be trained once a sufficiently large number of activity switch count data ASij is obtained for each switch type. In this stage, respective sets of activity switch counts ASij are determined for respective mutually different time windows and based on the distributions obtained in the preceding steps one or more of a respective X-factor, Y-factor and Z-factor is computed in steps S3A. In combination with a respective ground truth E_{GT} these are used as training data for the neural network. In step S4A the neural network computes a tentative indication E/−E and this is compared in step S5 with the respective ground truth E_{GT} to compute a loss with which the neural network parameters are updated, for example by backpropagation. As noted above, an indication of the ground truth may be obtained for example by a measurement of the progesterone level, e.g. in the milk produced by the mammal or may be determined by an ultrasound measurement. Also a successful insemination may serve as an indicator of the ground truth.

The training is completed if the neural network is capable to predict the indication E/−E sufficiently reliable. This can be verified with a test set, i.e. respective sets of activity switch counts ASij and their respective ground truth E_{GT}, which were not used for training.

In the following section experimental results are discussed

An offline dataset was collected as follows. All the cows were equipped with a collar-mounted sensor (Nedap Smart Tag 2.0 neck). During the research the detected estruses, sensor recorded behavior and progesterone levels were collected. The progesterone measurements were used as ground truth for evaluation. Information about the dataset is provided in Table 1.

TABLE 1
Dataset description

| | |
|---|---|
| # cows | 239 |
| # estruses | 517 |
| # silent events | 85 |
| # behavioral estrus events | 432 |

The 432 estrus events detected by Nedap smart tag are considered behavioural estruses. The remainder 85 of the progesterone detected estruses in the dataset are considered silent estruses. This shows that 20% of the estruses are possibly silent.

The dataset contains behavioral estruses detected by the Nedap system, bi weekly progesterone level measurements, sensor data, and general cow data (calving events, insemination events, pregnancy check events, etc.). The sensor data includes activity level data at a 15 minute frequency, and a complete timeline describing the current behavior of the cow at any point in the day in 4 states (state 0, state 1, state 2, state 3, for example eating, lying, panting, drinking).

FIG. 5A schematically shows exemplary timeline data in the data format used herewith. The data format specifies the identified activity and its duration In this example the timeline data shows that the sensed activities and their duration are subsequently state 0 (12 min), state 1 (20 min), state 2 (10 min), state 3 (10 min), state 0 (12 min) and state 1 (20 min).

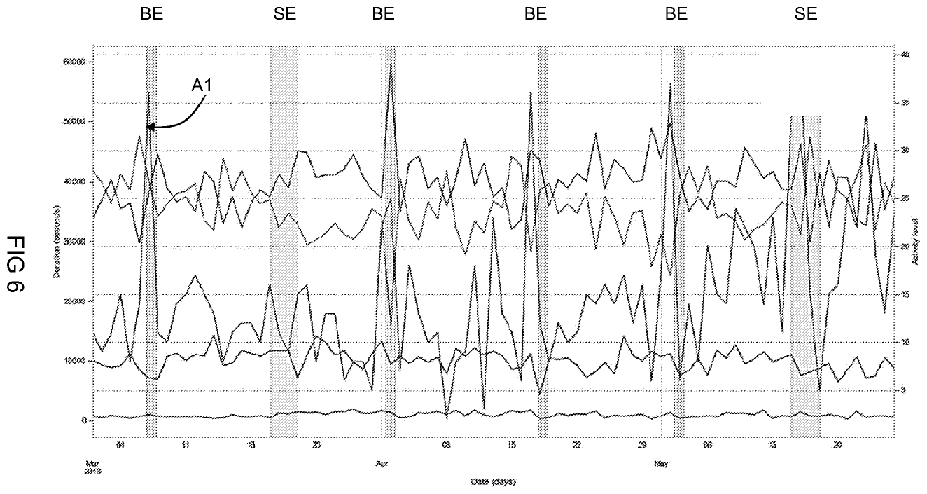

The plot in FIG. 6 shows the time spend per activity per day of one of the cows in the dataset. As can be observed, this cow has a periodic estrus cycle. The behavioural estrus events are indicated as BE and the silent estrus events are indicated as SE. The behavioural estrus events BE were automatically detected by the Nedap estrus detection system. As can be observed, for this particular cow most of the behavioural estrus events are characterised by their increase in activity level A1.

FIG. 6 also shows the difference between silent estrus events. The first silent estrus does not seem to show any obvious changes in behavior, but the second silent estrus clearly shows an increase in activity level. This clearly shows that silent estrus events can mutually differ, some events have no increased activity while others do have.

In the experimental setup described below, Python (v3.7.6) was used for implementing the silent estrus detection algorithm. Python is an high-level, general-purpose programming language that is widely used for machine learning due to its many libraries that contain tools for easy data processing and classification.

In order to evaluate the general silent estrus detection performance of the developed model the dataset is split into 70% training and 30% test data.

The golden standard used herein to determine the performance of an estrus detection model is the presence of estrus as indicated by progesterone levels in the milk.

The model will perform binary classification that classifies estrus and non-estrus. Correctly identified estrus events are considered true positives (TP), non detected estrus events are false negatives (FN). Non detected non-estrus events are true negatives (TN), detected non-estrus events are considered false positives (FP). The classifier uses a windowing approach to take into account the coarse grained nature of the ground truth. Since it is unknown when exactly the silent estrus event begins and ends, the positive classification results will be considered a true positive if part of the data in a window overlaps the suspected estrus period of a predetermined number of days around a silent estrus event indicated by the progesterone level.

The accuracy (Ac) is the ratio of correctly predicted observations to the total observations.

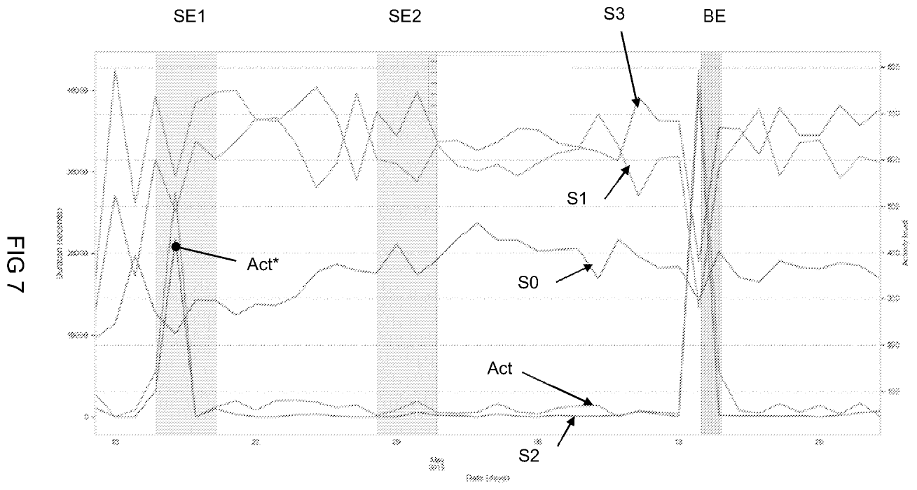

FIG. 7 shows the measurement values obtained for the following parameters “State 0 (S0)”, “State 1 (S1)”, “State 2 (S2)”, “State 3 (S3)” and “Activity (Act)”. The vertical axis shows the duration of these activities. The horizontal axis shows the day of observation. The animal observed herein experienced two silent estruses (SE1, SE2) and one behavior estrus (BE). The first silent estrus event SE1 therein is characterized by an increase in activity Act**, however the increase in activity was not substantial enough to be noticed by the currently used estrus detection system. The other silent estrus event SE2 shows no distinctive changes in the graph during the period of the event.

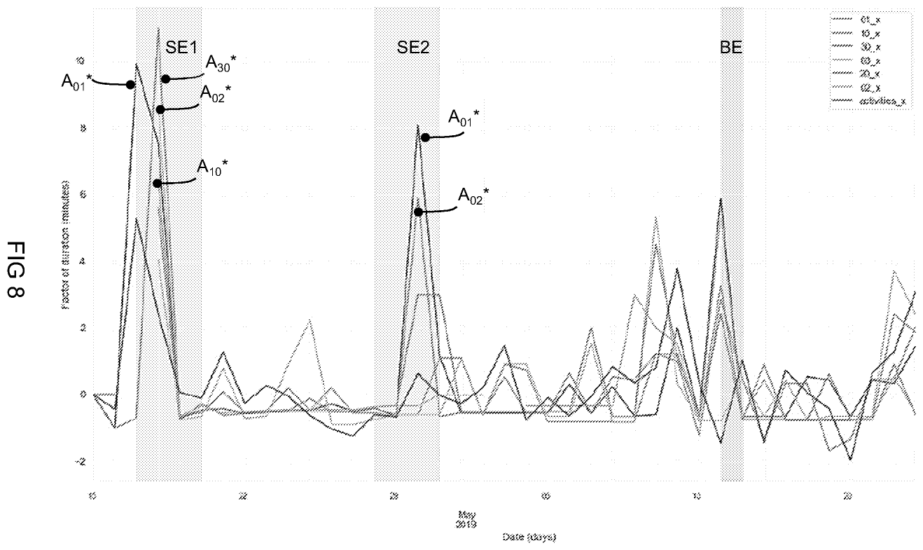

FIG. 8 shows for the same cow over the same period of time the following activity switch counts A₀₁, A₁₀, A₀₂, A₂₀, A₀₃, A₃₀, and “activities x”. Therein A₀₁, A₁₀, are the counts for a switch from “State 0” (S0) to “State 1” (S1) and reversely. A₀₂, A₂₀, are the counts for a switch from “State 0” (S0) to “State 2” (S2), and reversely. A₀₃, A₃₀ are the counts for a switch from “State 0” (S0) to “State 3” (S3) and reversely.

In FIG. 8, it can be readily seen that the activity switch counts Aij provide a clear indication for the presence of a silent estrous state. For example during the second silent estrus SE2, which was not detectable with the features shown in FIG. 7 a sharp increase A₀₁* and A₃₀* can be observed for the switch counts A₀₁ and A₃₀ respectively in FIG. 8. In addition to these switch counts, also a significant increase A₁₀* and A₀₂* for the counts A₁₀ and A₀₂ during the silent estrus SE1. It was found that an XGBoost model was capable to detect silent estrus events on the basis of the activity switch counts. Therewith accuracies in the order of 95% were achieved.

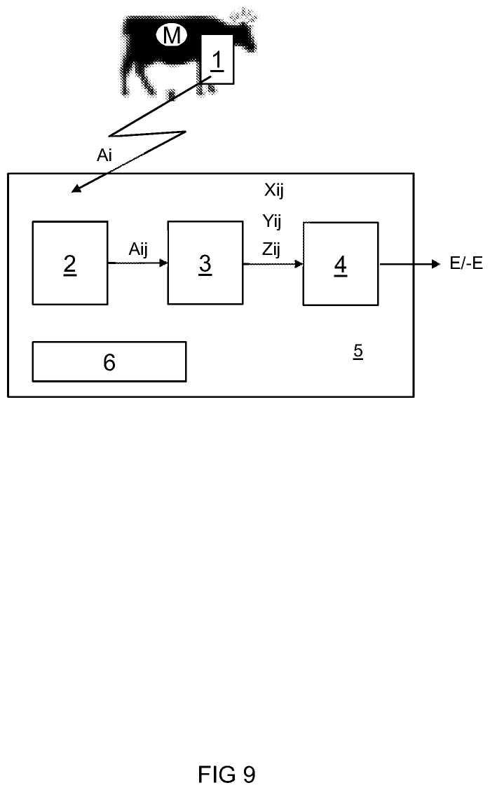

FIG. 9 schematically shows a system for estrus detection of a mammal, comprising first, second, third and fourth system elements.

The first system elements 1 are configured to obtain activity data Ai indicative for a degree and/or type of activity as a function of time for an activity of the mammal (M), an indicated degree and/or type of activity being selected from at least two potential indications for a degree and/or type of activity. In exemplary embodiments the first system elements include one or more motion detectors and/or acceleration detectors are incorporated in a neck tag, leg tag, ear tag, rumen bolus carried by the mammal. In other exemplary embodiments the first system elements 1 alternatively or additionally include a machine vision system that provides activity data on the basis of analysis of camera data.

The second system elements 2 are configured to determine one or more activity switch counts Aij indicative for a number of switches in said activity data during a predetermined time interval. The third system elements 3 are configured to compute respective activity switch scores Xij, Yij, Zij indicative for an extent to which said activity switch counts deviate from a distribution of said activity switch counts. The score can also be expressed as a percentage of the total number of switches.

The fourth system elements 4 are configured to determine whether or not (E/−E) the mammal is in estrus on the basis of said respective activity switch scores.

In the example of FIG. 9, the first system elements 1 wirelessly transmit the activity data Ai to the second system elements 2.

In some embodiments a second, third and fourth system elements 2, 3, 4 are integrated. The second, third and fourth system elements 2, 3, 4 can for example be provided as respective software modules that are executed by a general purpose computer. In the example of FIG. 9, a record-carrier 6 is provided that comprises a computer program with instructions that causes a general purpose computer 5 to function as the second, third and fourth system elements. Alternatively one or more of the second, third and fourth system elements 2, 3, 4 are implemented in dedicated hardware. In some embodiments the second, third and fourth system elements 2, 3, 4 are integrated with the first system element 1. In an example thereof the system elements 1-4 are integrated in a label worn by the mammal. More typically the first system element 1 is provided separately from the second, third and fourth system elements 2, 3, 4.

1. A method for estrus detection of a mammal, the method comprising:
obtaining activity data indicative for a degree and/or type of activity as a function of time for an activity of the mammal, wherein an indicated degree and/or type of activity is selected from at least two potential indications for a degree and/or type of activity;
determining one or more activity switch counts indicative for a number of switches in indicated type and/or degree of activity during an evaluation time interval of a predetermined duration;
computing respective relative activity switch scores for the activity switch counts; and
determining whether the mammal is in estrus based on the respective relative activity switch scores.

2. The method according to claim 1, wherein the respective relative activity switch score of an activity switch count is a percentage of the active switch count relative to a total count of switches.

3. The method according to claim 2, wherein the respective relative activity switch score of an activity switch count indicates how the percentage of the active switch count relative to a total count of switches relates to at least one estimated overall distribution of the percentage.

4. The method according to claim 1, wherein the mammal is a mammal type taken from the group consisting of: cattle, zebu, and buffalo.

5. The method according to claim 3, wherein the at least one estimated overall distribution comprises one or more of the group consisting of:
a first distribution obtained for respective mutually non-overlapping time intervals of the predetermined duration in a first period of time, and
a second distribution of activity switch scores obtained for respective mutually non-overlapping time intervals of the predetermined duration in a second period of time which is shorter than the first period of time.

6. The method according to claim 5, wherein the second period of time starts not more than 30 days before the predetermined time interval.

7. The method according to claim 5, wherein a length of the second period of time is at least five times shorter than a length of the first period of time.

8. The method according to claim 1, wherein the at least two potential indications for a degree and/or type of activity include an indication of the absence of an activity and an indication of a presence of an activity.

9. The method according to claim 1, wherein the at least two potential indications for a degree and/or type of activity include one or more of an indication of activity of the mammal taken from the group consisting of: eating, drinking, grooming, panting, perching, licking, grazing, sleeping, resting, ruminating, being inactive, lying on its left side, lying on its right side, standing, walking, standing up, lying down, and changing lying position from left to right or vice versa.

10. The method according to claim 1, wherein activity data is obtained using one or more motion detectors and/or acceleration detectors carried by the mammal.

11. The method according to claim 10, wherein the one or more motion detectors and/or acceleration detectors are incorporated in one or more structures carried by the mammal taken from the group consisting of: a neck tag, a leg tag, an ear tag, and a rumen bolus.

12. The method according to claim 1, wherein the determining that the mammal is in estrus on the basis of the activity switch scores is performed using a trained machine learning model.

13. The method according to claim 12, comprising training the trained machine learning model using a plurality of sample data pairs obtained for mutually different sample time intervals, wherein each sample data pair for a sample time interval includes:
a respective set of activity switch scores obtained for the sample time interval, and
a hormone concentration value obtained by measurement of a concentration of a hormone associated with an estrus state of the mammal in milk or blood delivered by the mammal during the sample time interval.

14. The method according to claim 12, wherein the machine learning model comprises a model type taken from the group consisting of: an XGBoost classifier, a Gradient Boost classifier, a naïve Bayes classifier, a support vector machine, and a decision tree classifier.

15. A system for estrus detection of a mammal, the system comprising:
first system elements configured to obtain activity data indicative for a degree and/or type of activity as a function of time for an activity of the mammal, wherein an indicated degree and/or type of activity is selected from at least two potential indications for a degree and/or type of activity;
second system elements configured to determine one or more activity switch counts indicative for a number of switches in indicated type and/or degree of activity during an evaluation time interval of a predetermined duration;
third system elements configured to compute respective relative activity switch scores for the activity switch counts; and
fourth system elements configured to determine whether the mammal is in estrus based on the respective activity switch scores.

16. A non-volatile computer-readable medium comprising a computer program including instructions that cause a general purpose computer to perform a method for estrus detection of a mammal, the method including the following operations:
obtaining activity data indicative for a degree and/or type of activity as a function of time for an activity of the mammal, wherein an indicated degree and/or type of activity is selected from at least two potential indications for a degree and/or type of activity;
determining one or more activity switch counts indicative for a number of switches in indicated type and/or degree of activity during an evaluation time interval of a predetermined duration;
computing respective relative activity switch scores for the activity switch counts; and
determining whether the mammal is in estrus based on the respective relative activity switch scores.

17. The method according to claim 1, wherein the respective relative activity switch score of an activity switch count indicates how the activity switch count relates to at least one estimated overall distribution of the activity switch counts.

18. The method according to claim 17, wherein the at least one estimated overall distribution comprises one or more of the group consisting of:
a first distribution obtained for respective mutually non-overlapping time intervals of the predetermined duration in a first period of time, and
a second distribution of activity switch scores obtained for respective mutually non-overlapping time intervals of the predetermined duration in a second period of time which is shorter than the first period of time.

19. The method according to claim 18, wherein the second period of time starts not more than 30 days before the predetermined time interval.

20. The method according to claim 19, wherein a length of the second period of time is at least five times shorter than a length of the first period of time.
